(19) United States
(12) Patent Application Publication
(10) Pub. No.: US 2004/0197684 A1
(43) Pub. Date: Oct. 7, 2004

(54) Composition and method for 3-dimensional mapping or radiation dose

(75) Inventors: Janette Anyumba, Wayne, NJ (US); David F. Lewis, Monroe, CT (US); Hsiao-Yi Shih, Whippany, NJ (US); Xiang Yu, Bridgewater, NJ (US)

Correspondence Address: Attn: William J. Davis, Esq., INTERNATIONAL SPECIALTY PRODUCTS, Legal Department, Building No. 10, 1361 Alps Road, Wayne, NJ, 07470, US

(73) Assignee: ISP INVESTMENTS INC.

(21) Appl. No.: 10/812,125

(22) Filed: Mar. 29, 2004

Related U.S. Application Data
(60) Provisional application No. 60/459,559, filed on Apr. 1, 2003.

(51) Int. Cl. G03C 1/73; G03C 5/00

(52) U.S. Cl. 430/30; 430/270.1

(57) ABSTRACT

In accordance with this invention, there is provided a method of imaging, measuring and displaying a 3-dimensional dose distribution of an energy field in a translucent 3-dimensional object comprises: applying an energy field to the object such that the optical properties are changed upon receipt of the energy; optically scanning the object at various positions and angles to provide a series of 2-dimensional representations of the object; detecting the measuring light projection data indicative of optical changes in the object; calibrating the optical change in the object to the dose of the energy corresponding to each position scan; mapping the dose of the energy in the object and visually recording the summation of said 2-dimensional representations on an image display receiver comprising a radiation activated metal salt of a crystalline, thermochromic polyacetylene having a conjugated structure uniformly distributed in a rigid or high density semi-solid matrix by a color alteration due to polymerization of the activated polyacetylene to provide a permanent, 3-dimensional image of the object in high spatial resolution. The invention further provides image display receivers and radiation sensitive materials.

### CROSS-REFERENCE TO RELATED PATENT APPLICATION

This application is based upon Provisional Application Serial No. 60/459,559, filed Apr. 1, 2003.

This invention relates to the 3-dimensional mapping and visualization of radiation fields obtained by the summation of a series of 2-dimensional sectional radiation exposures of a receiver, which receiver comprises the metal salt of a crystalline, polyacetylene monomer having a conjugated structure that is uniformly dispersed in a rigid or high density semi-solid matrix and is capable of absorbing emissions when light, X-ray, γ-ray, neutrons, electron beam, proton or other forms of radiation are passed through the tissue, or any other translucent object under investigation, and recording and displaying the summation of the individual 2-dimensional radiation exposures to provide a 3-dimensional representation of the tissue or object.

The polyacetylene monomer dispersed in the matrix may be activated by forming the metal salt of a monomeric, anionic polyacetylene species, and the matrix is polymerized and crosslinked at an elevated temperature. This activated dispersion may be exposed to a three dimensional radiation field causing the activated polyacetylene monomer to polymerize. The polymerized polyacetylene is colored and at any location in the irradiated sample, the color deepens in proportion to the absorbed dose of radiation at that point. The radiation exposure thus results in a three-dimensional colored image. Readout of that image is effected, at a temperature up to about 100° C., by a scanning process, for example with a tomographic optical scanner that measures the planar distributions of optical attenuation at a certain wavelength.

In the present 3-dimensional imaging process, scanning and imaging of the radiated object under investigation is accomplished by standard tomography and dosimetry methods disclosed in U.S. Pat. Nos. 5,633,584; 5,321,357 and 6,218,673B1 and review articles published in Med. Phys. 22/951/1995 and 22/1540/1995; Phys. Med. Biol. 23/1176-1182 and 25/117-127, which methods involve measuring the attenuation coefficient of the irradiated polyacetylene polymer at several optical wavelengths. More specifically, diametrically opposed radiation source and image display receiver are rotated around the stationary object during scanning or the object is rotated between a fixed radiation source and image receiver. The light transmitted to the receiver and position of the object with respect to the receiver in one of a plurality of radiation exposures is recorded and used to calculate one in a series of two dimensional images, thus providing data representing the radiation absorbance of the object at different positions or angles. The data obtained at the various exposure positions is collected and combined to provide a 3-dimensional image on the display receiver. The heat generated or applied during scanning causes polymerization of the dispersed monomer salt at points where the radiation passing through the object impinges on the receiver. Subsequent cooling of the matrix containing the radiation polymerized polyacetylene produces a visual 3-dimensional image of the object in high special resolution. Co-acting with the scanner is a recorder which records and stores the data received from exposure of the object at different wavelengths. Since this data is an opaque medium, it is necessary to heat the recorder contents to provide optical transparency and make such data available to the scanner so that it can be passed on to the receiver.

The polyacetylene monomer component uniformly dispersed in the matrix of the display receiver is a C₄ to C₄₀ crystalline, polyacetylene having a conjugated structure and is represented by the formula:

A—(CH₂)ₘ—(C≡C—)ₚ—(CH₂)ₙ—B

wherein m and n each independently have a value of from 0 to 30; p has a value of 2 to 4; A and B each independently are R, OR₁, OH, COOR₂, CONR₃R₄ or (CH₂)ᵣ—O—CO—NR₅R₆ or a metal salt of the acid or ester; and where R, R₁, R₂, R₃, R₄, R₅ and R₆ are each independently hydrogen or C₁ to C₁₂ alkyl or aryl and r has a value of from 1 to 4. Also mixtures of the above monomers can be employed.

Of these, pentacosa-10,12-diynoic acid (PCDA) and eicosa-5,7-diynoic acid (ECDA) are preferred.

The matrix of the invention can be any solid or high-density material which is chemically inert to the polyacetylene monomer and polymer and which is capable of transmission and minimizes diffusion of the image transferred by irradiation to the polyacetylene or receiver. Suitable examples of such matrices include but are not limited to gelatin, collagen and polyvinyl alcohol. The matrix, usually employed is a 1-40 wt % aqueous solution, preferably a 2-20 wt % aqueous solution, is used in a concentration of from about 100:1 to about 1:10, preferably from about 2:1 to about 1:4, with respective polyacetylene monomer.

The polyacetylene monomer or oligomer initially dispersed in the matrix is a conjugated, matrix insoluble crystalline compound of the above formula.

The polyacetylene monomer is employed as a composition containing from about 1 to about 50 wt % aqueous solution of a base, preferably an organic base, e.g. tetraethyl ammonium hydroxide, tetramethyl ammonium hydroxide, tetrapropyl ammonium hydroxide; from about 0.05 to about 10 wt % of an activator such as a water soluble lithium salt, e.g. lithium acetate, lithium chloride, etc., and 0.01-1 wt % of a gelatin crosslinking agent, e.g. formaldehyde, glyoxal, and 0.001-5 wt % of an antioxidant, e.g. propyl gallate, butylated hydroxyanisole. The radiation sensitive polyacetylene composition is prepared by dissolving a polyacetylene carboxylate monomer in an aqueous solution of a base, preferably an organic base, e.g. tetraethyl ammonium hydroxide and heated to dissolve the polyacetylene. A minor amount up to 7 wt. % of an aqueous solution of a metal salt of a C₁ to C₄ carboxylate, e.g. lithium acetate, is mixed with the dissolved polyacetylene thus forming the corresponding metal salt of the polyacetylene monomer, e.g. lithium pentacosa-10,12-diynoate which exhibits increased photosensitivity compared to the parent polyacetylene carboxylate. The resulting polyacetylene composition is additionally mixed with 0.3 to 10 wt. % of a polyfunctional crosslinking agent, e.g. an aqueous solution of formaldehyde, and 0.3 to 10 wt. % of an antioxidant, e.g. an alcohol solution of an alkylated hydroxy ether, e.g. butylated hydroxyanisole.

Representative examples of preferred embodiments for the preparation of the image display receiver and use in 3-dimensional mapping is described in the following examples.

### EXAMPLE 1

Part A is prepared by dissolving a bone gelatin in water to provide a 10% solution.

Part B is prepared by mixing 5 g of eicosa-5,7-diynoic acid (ECDA) and an equimolar amount of a 20% aqueous solution of tetraethyl ammonium hydroxide together with water to bring the total weight to 100 g. The mixture is heated to about 70° C. and stirred to dissolve the ECDA. The resulting solution of tetraethyl ammonium eicosa-5,7-diynoate is filtered.

Part C is a 10% solution of lithium acetate in water.

A radiation sensitive composition is prepared by mixing (at about 50° C.) 10 g of Part A with 10 g of Part B and further adding and mixing 1 g of Part C. Initially the mixture is clear and transparent, but quickly becomes substantially more viscous than any of the component solutions. When a small portion of this mixture is exposed to short wavelength UV light there is no color change. This indicates that the clear transparent mixture is not photoactive.

Upon cooling the mixture to room ambient temperature (about 20° C.-25° C.) the composition solidifies and slowly turns milky white as crystals of an active component form. At this stage, the composition has become photoactive as evidenced by the appearance of a bright red coloration upon exposure to a short wavelength UV lamp. The mixture becomes more photoactive with time until it attains its maximum photoactivity.

After a few hours, a portion of the sample is heated to about 50° C. whereupon it melts to a viscous liquid. When the mixture is held at this temperature it gradually becomes clear and transparent, signifying the dissolution of the active component within the matrix. Once again, the clear mixture is not photoactive. Nevertheless, when the sample is again cooled to room ambient temperature the sample returns to its milky white color as the active component again crystallizes and the mixture once more becomes photoactive.

The sample is irradiated with a beam of x-rays at room ambient temperature. The beam is such that it irradiates only part of the sample, the other portion remaining substantially unexposed by the radiation. Where exposed, the sample immediately turns bright red, the unexposed portion remaining substantially uncolored. The sample is now heated to about 50° C., at which point it becomes transparent. The portion that was irradiated retains its bright red coloration and the unexposed portion is substantially uncolored. However, the sample is a viscous liquid, and if the sample is shaken, stirred or otherwise disturbed, the color of the sample becomes homogeneous and the portion of the sample that was exposed to the x-rays becomes indistinguishable from the portion that was not exposed.

Upon irradiation of other samples of the mixture at room ambient temperature it is observed that the color change becomes progressively darker in proportion to the amount of exposure to the x-ray beam.

### EXAMPLE 2

Part A is prepared by dissolving an acid-processed pork skin gelatin in water to provide a 10% solution.

Part B is prepared by mixing 5 g of pentacosa-10,12-diynoic acid (PCDA) and an equimolar amount of a 20% aqueous solution of tetraethyl ammonium hydroxide together with water to bring the total weight to 100 g. The mixture is heated to about 70° C. and stirred to dissolve the PCDA. The resulting solution of tetraethyl ammonium pentacosa-10,12-diynoate is filtered.

Part C is a 5% solution of lithium acetate in water.

Part D is a 1% solution of formaldehyde in water.

A radiation sensitive composition is prepared by mixing (at about 50° C.) 2 g of Part A with 2 g of Part B and further adding and mixing 0.2 g of Part C. This mixture is clear and transparent and has a viscosity markedly higher than the components. The clear mixture is unreactive when exposed to short wavelength UV. Upon the addition of 0.05 g of Part D, the viscosity of the mixture rapidly increases, but remains transparent. The mixture is then cooled to room ambient temperature (about 20° C.-25° C.) whereupon it slowly turns milky white as crystals of a photoactive component form. The mixture is now photoactive and develops a dark blue color upon exposure to short wavelength UV.

After a few hours, a portion of the sample is heated to about 60° C. The sample does not liquefy. This demonstrates that the formaldehyde has reacted with the gelatin to transform it to a rigid, crosslinked matrix. In addition, it is observed that the mixture becomes clear and transparent, signifying the dissolution of the active component within the matrix. In this form, the composition is not photoactive and there is no color development when the sample is exposed to UV light.

Nevertheless, when the sample is again cooled to room ambient temperature it returns to its milky white color as the active component crystallizes once again.

A portion of the sample is then irradiated with a beam of x-rays at room ambient temperature. The absorbed dose of radiation is about 10 Gy. The beam is such that it irradiates only part of the sample, the other portion remaining substantially unexposed by the radiation. Where exposed, the sample immediately turns dark blue, the unexposed portion remaining substantially uncolored. The sample is now heated to about 60° C. The color of the exposed portion of the sample changes from dark blue to dark red and the composition becomes transparent. The sample does not melt. Because the matrix remains rigid, the red-colored portion of the sample that was previously exposed to radiation does not mix or diffuse into that portion of the sample that was not irradiated. The two parts of the sample retain their integrity.

Upon x-ray exposure at room ambient temperature of other samples prepared with the preceding formulation, it is observed that the blue color becomes progressively darker in proportion to the amount of exposure to the x-ray beam. Nevertheless, these samples also become red and transparent when heated to about 60° C. although it also observed that the red coloration becomes progressively more intense with increasing x-ray exposure.

### EXAMPLE 3

The formulation of Example 2 is used to make a sample mixture except that the PCDA is replaced with ECDA. When this composition is cooled to room temperature and irradiated with a 10 Gy dose of x-rays, the exposed portion of the sample turns bright red. When the sample is subsequently heated to about 60° C., the red color remains, but the sample becomes transparent. However, in contrast to the observations in Example 1, the sample of Example 3 does not melt and remains solid. The integrity of the red colored portion of the sample is retained since the exposed portion of the sample does not mix with or diffuse into the unexposed portion of the sample. This demonstrates the value of adding an agent such as formaldehyde to crosslink the gelatin in the composition and prevent it from melting.

### EXAMPLE 4

The formulation of Example 1 is used to make a sample mixture except that 0.25 g of a 1% aqueous solution of formaldehyde is added after the other components are mixed. As in Example 4, the composition becomes white and opaque at room temperature and when it is irradiated with a 10 Gy dose of x-rays, the exposed portion of the sample turns bright red. When the sample is subsequently heated to about 60° C., the red color remains. However, although the sample becomes somewhat clear it does not reach the high transparency attained for any of the Examples 1-3.

When 0.25 g of 1% aqueous formaldehyde is added to 10 g of a 10% solution of the lime-bone gelatin at about 50° C., the viscosity of the solution slowly increases, but the sample becomes distinctly hazy. In contrast, when the same is done to a 10% solution of the acid-process pork skin gelatin the sample solidifies rapidly and it remains clear and transparent. This demonstrates the value of choosing a particular gelatin if it is desirable for compositions comprising the gelatin to retain high transparency and to solidify rapidly after adding formaldehyde or other crosslinking agent.

### EXAMPLE 5

Two samples were prepared according to the composition of Example 2. After the addition of formaldehyde, Sample 5A was maintained at 60° C. for 4 hours and then refrigerated for about 36 hours. After addition of formaldehyde to Sample 5B, the sample was immediately refrigerated for about 16 hours. At the end of the 16 hour time period Sample 5B appeared milky white and exposure of the sample to a 10 Gy dose of x-rays caused a dark blue coloration of the sample. In contrast, Sample 5A was translucent and only faintly milky even after 36 hours refrigeration. When it was subjected to a 10 Gy dose of x-rays there was barely any development of color.

Another pair of samples was prepared, but without the addition of formaldehyde. Sample 5C was maintained at 60° C. for 4 hours and refrigerated for about 36 hours. Sample 5D was refrigerated for about 16 hours. When taken from the refrigerator Samples 5C and 5D were both milky white and developed equally dark blue coloration when exposed to a 10 Gy dose of x-rays.

These experiments demonstrate the importance of the environmental treatment of the sample following addition of formaldehyde. In general, to maximize sensitivity, it is desirable to maintain the composition at relatively lower temperature after addition of the crosslinking agent. It is believed that higher temperatures promote more rapid crosslinking of the gelatin and that crystals of the radiation sensitive components grow less quickly in a more highly crosslinked matrix.

### EXAMPLE 6

Sample 6A was prepared according to the composition of Example 2. Sample 6B was prepared similarly except that before the addition of the formaldehyde solution an addition was made of 0.2 g of a 2% solution of butylated hydroxyanisole (BHA) in methanol. BHA is an antioxidant.

The samples were cooled to room ambient temperature of about 22° C. and kept at this temperature for a week. Visual observation of Sample 6A showed that it was very pale blue while Sample 6B was still white. This demonstrates that an antioxidant is effective in limiting the dark reaction of the active component in the Sample 6B.

Furthermore, when the samples were subsequently exposed to office light for 24 hours Sample 6A became much darker blue while Sample 6B remained white. This demonstrates that an antioxidant is also effective in limiting the visible light sensitivity of the active component in the Sample 6B.

Duplicate amounts of Samples 6A and 6B were prepared. After the samples had remained at room ambient temperature for about 24 hours both were irradiated with 10 Gy of x-rays. Observation of the irradiated samples showed that they had developed a dark blue coloration. The intensity of the coloration in the two samples was indistinguishable, demonstrating that the samples had equal sensitivity to the x-ray exposure.

### EXAMPLE 7

Sample 7 was prepared as in Example 2 except that the quantities of the ingredients were increased by a factor of 4. Sample 7 was contained in a cylindrical glass vial about 1.6 cm in diameter.

After the sample had sat at about 22° C. for 48 hours it was irradiated through a mask with about a 10 Gy dose of 120 kVp x-rays. The mask consisted of about 1″ thickness of steel with a circular hole about 5 mm in diameter. The hole in the mask was aligned radially with the sample and effectively permitted the sample to be exposed to a circular beam of x-rays. After the exposure, the points where the beam entered and exited the sample were visually evident as dark blue spots. The sample was then rotated about 90° around the cylindrical axis and a second dose of 10 Gy was administered. Again, the entry and exit points of the beam were visible as dark blue spots.

The sample was then warmed to 60° C. at which time the sample became clear and transparent, although the blue coloration caused by exposure turned to a deep red color. The path of the x-ray beam through the sample was clearly revealed as two red-colored, approximately cylindrical sections passing radially through the sample at about 90° to one another. Where these sections intersected near the center of the sample, it was evident that the red coloration was more intense, indicating that this section of the sample had received a higher exposure.

### EXAMPLE 8

Parts A, B and C were prepared in the manner described in Example 2. Equal portions of Part A and Part B were mixed and heated to about 70° C. 5 g aliquots of this mixture were then taken and to each aliquot was added a weighed amount of Part C to prepare a set of samples in which the molar ratio of lithium to pentacosa-10,12-diynoate was 0.1:1, 0.2:1, 0.3:1, 0.4:1, 0.5:1, 0.6:1, 0.7:1, 0.8:1, 0.9:1 and 1:1. The samples were well mixed, heated to 70° C. and then plunged into ice to set the gelatin. The samples were then refrigerated for about 16 hours. At the end of this period, small portions of the samples were taken and exposed to short wavelength UV light. The relative sensitivities of the samples are shown in the following Table.

TABLE

| Molar ratio of Li:PCDA | Sensitivity |
|---|---|
| 0.1:1 | No sensitivity |
| 0.2:1 | Low sensitivity |
| 0.3:1 | Very high sensitivity |
| 0.4:1 | Very high sensitivity |
| 0.5:1 | Very high sensitivity |
| 0.6:1 | Very high sensitivity |
| 0.7:1 | Very high sensitivity |
| 0.8:1 | Very high sensitivity |
| 0.9:1 | Low sensitivity |
| 1:1 | Low sensitivity |

Similar results were obtained after more small portions of the samples were taken and exposed to x-rays generated at 100 kVp and filtered through 2 mm of aluminum.

### EXAMPLE 9

The sample preparation and process described in Example 2 were repeated except that in Part B, tetramethylammonium hydroxide was substituted for tetraethylammonium hydroxide. The results and observations were the same as for Example 2. The sensitivities of the samples of this Example and of Example 2 were essentially the same.

### EXAMPLE 10

The sample preparation and process described in Example 2 were repeated except that in Part B, tetrapropylammonium hydroxide was substituted for tetraethylammonium hydroxide. The results and observations were the same as for Example 2. The sensitivities of the samples of this Example and of Example 2 were essentially the same.

### EXAMPLE 11

The sample preparation and process described in Example 2 were repeated except that in Part B, sodium hydroxide was substituted for tetraethylammonium hydroxide. The results and observations were similar to those in Example 2. However, the sensitivities of the sample of this Example were about 4X less than the sensitivity of the sample of Example 2. Similarly when potassium hydroxide was substituted for tetraethylammonium hydroxide in Part B, the sensitivity of the sample was diminished by about a factor of 4X.

### EXAMPLE 12

The sample preparation and process described in Example 2 were repeated except that in Part C sodium acetate was substituted for lithium acetate. The sensitivity of the sample of this Example was dramatically less than the sensitivity of the sample of Example 2. To produce the same color change in this Example it took >100X the dose required in Example 2. When other samples were prepared in which potassium acetate, cesium acetate or silver nitrate was substituted for the lithium acetate, they also exhibited the same dramatically decreased sensitivities.

### EXAMPLE 13

The sample preparation and process described in Example 2 were repeated except that in Part C lithium chloride was substituted for lithium acetate. The sensitivity of the sample of this Example was essentially the same as the sensitivity of the sample of Example 2.

What is claimed is:

1. A method of imaging, measuring and displaying a 3-dimensional dose distribution of an energy field in a translucent 3-dimensional object comprising:
(a) applying an energy field to the object such that the optical properties are changed upon receipt of the energy;
(b) optically scanning the object at various positions and angles to provide a series of 2-dimensional representations of the object;
(c) detecting the measuring light projection data indicative of optical changes in the object;
(d) calibrating the optical change in the object to the dose of the energy corresponding to each position scan;
(e) mapping the dose of the energy in the object and
(f) visually recording the summation of said 2-dimensional representations on an image display receiver comprising a radiation activated metal salt of a crystalline, thermochromic polyacetylene having a conjugated structure uniformly distributed in a rigid or high density semi-solid matrix by a color alteration due to polymerization of the activated polyacetylene to provide a permanent, 3-dimensional image of the object in high spatial resolution.

2. An image display receiver displaying a colored 3-dimensional representation of an object which comprises a homogeneous rigid or high density semi-solid composition derived from a polymerized metal salt of a crystalline, thermochromic polyacetylene having a conjugated structure uniformly dispersed in a rigid or high density semi-solid matrix.

3. An image display receiver for development of a 3-dimensional representation of an object which comprises a metal salt of a polymerizable, crystalline, thermochromic polyacetylene having a conjugated structure which is uniformly distributed in a rigid or high density semi-solid matrix.

4. The image display receiver of claim 2 wherein said crystalline polyacetylene is a C₂ to C₁₀ radiochromic monomer having the formula:
A—(CH₂)_{m—(C≡C—)}ₚ—(CH₂)ₙ—B
wherein m and n each independently have a value of from 0 to 30; p has a value of 2 to 4; A and B each independently are R, OR₁, OH, COOR₂, CONR₃R₄ or (CH₂)ᵣ—O—C—NR₅R₆ or a metal salt of the acid or ester; and where R, R₁, R₂, R₃, R₄, R₅ and R₆ are each independently hydrogen or C₁ to C₁₂ alkyl or aryl and r has a value of from 1 to 4.

5. The image display receiver of claim 2 wherein the metal salt of the crystalline polyacetylene is a lithium salt.

6. The image display receiver of claim 4 wherein said crystalline polyacetylene comprises a mixture of at least two of said monomers.

7. A radiation sensitive material comprising a C₂ to C₁₀ radiochromic monomer having the formula:
A—(CH₂)ₘ—(C≡C—)ₚ—(CH₂)ₙ—B
wherein m and n each independently have a value of from 0 to 30; p has a value of 2 to 4; A and B each independently are R, OR₁, OH, COOR₂, CONR₃R₄ or (CH₂)ᵣ—O—CO—NR₅R₆ or a metal salt of the acid or ester; and where R, R₁, R₂, R₃, R₄, R₅ and R₆ are each independently hydrogen or C₁ to C₁₂ alkyl or aryl and r has a value of from 1 to 4,
provided that at least one of A or B is COOH;
an organic base; and
a water soluble lithium salt, wherein the weight ratio of said lithium salt to said radiochromic monomer is 0.2:1 to 0.8:1.

8. The method of claim 1 wherein said crystalline polyacetylene is a C₂ to C₁₀ radiochromic monomer having the formula:
A—(CH₂)ₘ—(C≡C—)ₚ—(CH₂)ₙ—B
wherein m and n each independently have a value of from 0 to 30; p has a value of 2 to 4; A and B each independently are R, OR₁, OH, COOR₂, CONR₃R₄ or (CH₂)ᵣ—O—CO—NR₅R₆ or a metal salt of the acid or ester; and where R, R₁, R₂, R₃, R₄, R₅ and R₆ are each independently hydrogen or C₁ to C₁₂ alkyl or aryl and r has a value of from 1 to 4.

9. The method of claim 1 wherein the metal salt of the crystalline polyacetylene is a lithium salt.
